(19) United States
(12) Patent Application Publication
(10) Pub. No.: US 2006/0043658 A1
(43) Pub. Date: Mar. 2, 2006

(54) Fluid-filled vibration damping device

(75) Inventors: Eiji Tanaka, Komaki-shi (JP); Katsuhisa Yano, Inuyama-shi (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., Komaki-shi (JP)

(21) Appl. No.: 11/210,880

(22) Filed: Aug. 25, 2005

(30) Foreign Application Priority Data
Aug. 25, 2004 (JP) 2004-245327

(51) Int. Cl. F16F 13/00

(52) U.S. Cl. 267/140.13; 267/140.11

(57) ABSTRACT

A fluid-filled vibration damping device comprising: a rubber elastic body connecting the first and second mounting members; a first pressure receiving chamber partially formed by the elastic body; a first equilibrium chamber partially formed by a first flexible rubber layer; a first orifice passage connecting the first pressure receiving and equilibrium chambers. The elastic body has a pair of pockets open in its outer circumferential surface and located on both sides in a diametric direction of the support shaft of the first mounting member, while being fluid-tightly covered by the second mounting member to form a pair of operating fluid chambers which are connected by a second orifice passage. The operating fluid chambers functions as a second receiving pressure chamber partially formed by the rubber elastic body and a second equilibrium chamber partially formed by a second flexible rubber layer.

### INCORPORATED BY REFERENCE

The disclosure of Japanese Patent Application No. 2004-245327 filed on Aug. 25, 2004 including the specification, drawings and abstract is incorporated herein by reference in its entirety.

### BACKGROUND OF THE INVENTION

1. Field of the Invention

The present invention relates to a fluid-filled vibration damping device in which damping effects are obtained based on the flow action of a non-compressible fluid sealed in the interior thereof. More particularly, the invention is concerned with such a fluid-filled vibration damping device in which effective damping effects are brought about based on the flow action of a non-compressible fluid against input in both of two directions, i.e., the center axial direction and a direction perpendicular to the axis, making the device suitable for use as automobile engine mounts, for example.

2. Description of the Related Art

A fluid-filled vibration damping device having a non-compressible fluid sealed in the interior thereof is known as one type of known damping devices used as a damping connector or damping support mounted between members forming a vibration transmission system. The application of this type of vibration damping device to automobile engine mounts, for example, has been attempt, since extremely good damping effects can be obtained against vibrations in specific frequency ranges based on the flow action, such as resonance action, of the sealed non-compressible fluid.

Meanwhile, the damping effects of damping devices are sometimes needed for vibrations input from a plurality of directions. In the case of engine mounts which support automobile power units on the principal axis of inertia relative to the vehicle body, for example, a high degree of damping performance against vertical as well as longitudinal vibrations in the vehicle is generally required. It is thus desirable to ensure that damping effects based on the flow action of the sealed fluid are brought about in both of two directions which are perpendicular to each other.

To meet such demand, the present assignee has previously proposed a fluid-filled vibration damping device disclosed in JP-A-2002-327787. The fluid-filled vibration damping device disclosed in this application comprising: a first mounting member in the form of a rod attachable to the power unit side; a second mounting member in the form of a large-diameter cylinder attachable to the vehicle body side and having one opening side through which the first mounting member is inserted to be disposed therein; and a rubber elastic body interposed between and elastically connecting the first and second mounting members. An equilibrium chamber and pressure receiving chamber joined together by a first orifice passage are formed below the axial direction of the rubber elastic body, so that the disclosed damping device is able to exhibit damping effect, on the basis of resonance action of the fluid flowing through the first orifice passage between the equilibrium chamber and pressure receiving chamber, with respect to axially (vertical direction of vehicle) input vibrations. In addition, a pair of operating fluid chambers are formed on both sides of the first mounting member between the radial facing planes of the first and second mounting members, and the pair of operating fluid chambers are joined to each other by a second orifice passage. Accordingly, the disclosed vibration damping device is capable of exhibiting damping effect, on the basis of resonance action of the fluid flowing through the second orifice passage between the pair of operating fluid chambers, with respect to vibrations input in directions perpendicular to the axial direction (longitudinal direction of vehicle).

However, in the fluid-filled vibration damping device structured in this manner, the damping effects produced on the basis of the resonance action of the fluid flowing through the second orifice passage are relatively “peaky” during vibration input in axis-perpendicular directions, and a resulting problem was the narrow frequency range in which damping effects could be obtained. It was thus difficult to tune the vibration properties, and there was the risk that the intended damping performance could not be satisfactorily achieved as a result of changes in the properties of the damping device or the frequency of the input vibrations due to changes over time or the driving conditions or inherent conditions of the vehicle.

Additionally, the frequency range in which damping effects can be achieved based on the resonance action of the fluid flowing through the second orifice passage is tuned by adjusting the cross section area or length of the second orifice passage and by adjusting the wall spring rigidity of the pair of operating fluid chambers. However, since the wall springs of the operating fluid chambers are made of the rubber elastic body, adjustments of the wall spring rigidity directly affect the spring properties of the rubber elastic body, namely, the support spring rigidity of the damping device, and the like. Resulting problems are that, in actuality, it is extremely difficult to adjust the wall springs of the operating fluid chambers with a sufficient degree of freedom, and the degree of freedom with which the second orifice passage can be tuned is limited. Although tuning can be addressed based on the length and cross section area of the second orifice passage, the second orifice passage is also limited in terms of formable space or structure, or in terms of ensuring fluid flow volume.

JP-A-2002-327789 also proposes a structure in which the rubber elastic body is further formed with a pair of relatively large notch-formed voids opposed to each other with the first mounting member interposed therebetween, in one radial direction perpendicular to another radial direction in which the pair of operating fluid chambers are opposed to each other. These voids are utilized to form equilibrium chambers each partially defined by a flexible film, and two orifice passages are formed linking the equilibrium chambers to the operating fluid chambers, respectively. This structure can be used to deal with vibrations in a wider range of frequencies by tuning the orifice passages differently from each other.

In the damping device described in JP-A-2002-327789, the need to form appreciable voids for the rubber elastic body unavoidably results in a dramatic loss of support spring rigidity in the damping device main unit. It is thus not practical in fields requiring significant support spring rigidity. Furthermore, considering the fact that automobile engine mounts are often required to have high dynamic spring rigidity in the lateral direction of the vehicle in order to address transversal gravity when the vehicle travels around corners, the structure described in JP-A-2002-327789 for forming appreciable voids in the rubber elastic body area acting as the compression spring in the lateral direction of the vehicle is unlikely to be considered a desirable structure, at least for automobile engine mounts.

### SUMMARY OF THE INVENTION

It is therefore one object of this invention to provide a fluid-filled vibration damping device of novel structure, which is capable of providing damping effects on the basis of resonance action of a non-compressible fluid sealed therein with respect to vibrations in either the axial or axis-perpendicular directions, in particular, which ensures a degree of freedom in tuning a second orifice passage while ensuring sufficient axial support spring rigidity, and which is capable of exhibiting damping effects on the basis of the resonance action of the sealed fluid over a wider range of frequencies for vibrations input in axis-perpendicular directions.

It is another object of the present invention to provide a fluid-filled vibration damping device of novel structure, in which a greater spring ratio can be established in mutually-perpendicular axis-perpendicular directions, where effective damping performance on the basis of the resonance action of the sealed non-compressible fluid can be brought about in one axis-perpendicular direction, while effective high dynamic spring properties by the rubber elastic body can be ensured in another axis-perpendicular direction perpendicular thereto.

The above and/or optional objects of this invention may be attained according to at least one of the following modes of the invention. The following modes and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

A first mode of the invention provides a fluid-filled vibration damping device comprising: a first mounting member having a linearly extending support shaft; a second mounting member having a generally cylindrical shape and coaxially disposed with and axially spaced away from the first mounting member such that the support shaft of the first mounting member is inserted so as to extend axially inwardly from a first axial opening of the second mounting member; a rubber elastic body elastically connecting the support shaft of the first mounting member and the second mounting member so that the first axial opening of the second mounting member is fluid-tightly closed by means of the rubber elastic body; a first flexible rubber layer fluid-tightly closing an other opening of the second mounting member; a partition member supported by the second mounting member and disposed between the rubber elastic body and the first flexible rubber layer so as to extend in an axis-perpendicular direction of the second mounting member; a first pressure-receiving chamber partially formed by the rubber elastic body on one axial side of the partition member, having a non-compressible fluid sealed therein; a first equilibrium chamber partially formed by the first flexible rubber layer on an other axial side of the partition member, having the non-compressible fluid sealed therein; a first orifice passage permitting a fluid communication between the first pressure-receiving chamber and the first equilibrium chamber; a pair of pockets having openings open in an outer circumferential surface of the rubber elastic body and being located on both sides in a diametric direction of the support shaft of the first mounting member, the openings of the pair of pockets being fluid-tightly covered by the second mounting member so as to form a pair of operating fluid chambers partially formed by the rubber elastic body and having the non-compressible fluid sealed therein; and a second orifice passage permitting a fluid communication between the pair of operating fluid chambers, wherein the second mounting member includes a window opening provided in a portion covering one of the pair of operating fluid chambers, and the window opening is fluid-tightly closed by a second flexible rubber layer so that the one operating fluid chamber is partially formed by the second flexible rubber layer, thereby forming, by means of the pair of operating fluid chambers, a second receiving pressure chamber partially formed by the rubber elastic body so that pressure fluctuations are directly produced in conjunction with the elastic deformation of the rubber elastic body when vibrations are input in the axis-perpendicular direction between the first and second mounting members, and a second equilibrium chamber partially formed by the second flexible rubber layer so that changes in volume are readily accommodated through the deformation of the second flexible rubber layer.

In the fluid-filled vibration damping device formed according to this mode, a part of the wall of the second equilibrium chamber is formed by the second flexible rubber layer, so that the wall spring rigidity of the second equilibrium chamber can be adjusted, for example, by modifying the second flexible rubber layer size, thickness, slack, structural material, and the like to adjust the spring properties of the second flexible rubber layer.

The wall spring rigidity of the second equilibrium chamber can thus be adjusted with a considerable degree of freedom without adjusting the spring properties of the rubber elastic body which has such a significant influence on the axial support spring rigidity and the like in the fluid-filled vibration damping device. It is thus possible to ensure a greater degree of freedom in tuning the second orifice passage, that is, the degree of freedom relating to the damping effects based on the resonance action of the fluid flowing through the second orifice passage and to tuning the range of frequencies in which such effects can be brought about, while ensuring sufficient axial support spring rigidity.

Furthermore, in the fluid-filled vibration damping device formed according to this mode, changes in volume are readily accommodated through the deformation of the second flexible rubber layer in the second equilibrium chamber connected to the second pressure receiving chamber through the second orifice passage. Therefore, it is possible to control the peaky properties of the damping effects brought about on the basis of the resonance action of the fluid flowing through the second orifice passage. The damping effects based on the resonance action of the fluid flowing through the second orifice passage can thus be brought about over a greater range of frequencies.

Still furthermore, in the fluid-filled vibration damping device formed according to this mode, the second pressure receiving chamber and second equilibrium chamber are formed facing radially one way on both sides of the support shaft of the first mounting member, thus ensuring greater rubber volume in the rubber elastic body in the direction perpendicular to the direction in which the second pressure receiving chamber and second equilibrium chamber are facing. It is thus possible to establish a greater spring ratio in the direction in which the second pressure receiving chamber and second equilibrium chamber are facing and the direction perpendicular thereto.

In the fluid-filled vibration damping device formed according to this mode, it is possible to obtain damping effects, on the basis of the resonance action of the fluid flowing through the second orifice passage, in the direction in which the second pressure receiving chamber and second equilibrium chamber are facing. It is also possible to obtain effective high dynamic spring rigidity by the rubber elastic body in the radial direction perpendicular to the direction in which the second pressure receiving chamber and second equilibrium chamber are facing.

A second mode of the invention provides a fluid-filled vibration damping device according to the first mode, wherein both the first flexible rubber layer and second flexible rubber layer are bonded by vulcanization to the second mounting member, so that the other axial opening of the second mounting member is fluid-tightly closed by the first flexible rubber layer, and the window opening of the second mounting member is fluid-tightly closed by the second flexible rubber layer. In the fluid-filled vibration damping device with a structure according to this mode, the first and second flexible rubber layers can be collectively handled, simplifying the manufacturing process during the manufacture of the fluid-filled vibration damping device and reducing the number of handled parts.

A third mode of the invention is a fluid-filled vibration damping device according to the second mode, wherein the first and second flexible rubber layers are integrally formed of the same rubber material, and the seal rubber layer covering an inner circumferential surface of the second mounting member over generally an entire surface is integrally formed with the first and second flexible rubber layers and bonded by vulcanization to the second mounting member.

A fourth mode of the invention is a fluid-filled vibration damping device according to any of the first through third modes, wherein a generally cylindrical metal sleeve is bonded by vulcanization to an outer circumferential surface of the rubber elastic body, a pair of windows is formed in the metal sleeve, and wherein the pair of pockets formed in the rubber elastic body opens through the pair of windows to an outer circumferential surface of the metal sleeve, and the second mounting member is fitted and secured to the metal sleeve so that the pair of windows in the metal sleeve are fluid-tightly covered by the second mounting member. In the fluid-filled vibration damping device with a structure according to this mode, the fluid tightness at the location where the metal sleeve is fitted to the second mounting member is ensured, facilitating the mutually independent and highly fluid-tight formation of the first pressure receiving chamber and the first equilibrium chamber which communicate with each other by the first orifice passage, and the second pressure receiving chamber and second equilibrium chamber which communicate with each other by the second orifice passage.

A fifth mode of the invention is a fluid-filled vibration damping device according to any of the first through fourth modes, further comprising: an attachment bracket having cylindrical portion that are fitted and secured to the second mounting member so that the second flexible rubber layer disposed at the window opening of the second mounting member is covered from an outside by the cylindrical portion of the attachment bracket so as to form a sealed air chamber on a side opposite the second equilibrium chamber with the second flexible rubber layer interposed therebetween. In the fluid-filled vibration-damping device with a structure according to this mode, the spring properties of the second flexible rubber layer can be adjusted by utilizing the compressive elasticity of the air sealed in the air chamber formed on the opposite side from the second equilibrium chamber on both sides of the second flexible rubber layer. The damping effects based on the resonance action of the fluid circulating in the second orifice passage and the range of frequencies in which such effects can be brought about may therefore be tuned with an ever greater degree of freedom.

As will be apparent from the preceding description, in the fluid-filled type dynamic vibration damping device constructed according to the invention, a portion of the wall of one of the pair of operating fluid chambers located on both sides in the radial direction of the support shaft is made of the second flexible rubber layer separate from the rubber elastic body, so that a second equilibrium chamber is formed. This arrangement allows the radial damping properties obtained on the basis of the resonance action of the fluid flowing through the second orifice passage to be tuned with a greater degree of freedom by adjusting the configuration, properties, and the like of the second flexible rubber layer, while ensuring advantageous support spring rigidity with the rubber elastic body. Particularly in comparison to the fluid-filled vibration damping device relating to the prior application disclosed in JP-A-2002-327789, the damping effects based on the resonance action of the fluid which are brought about against radially input vibrations can be obtained over an even broader range of frequencies.

In the fluid-filled vibration damping device according to this mode, it is possible to ensure greater rubber volume in the rubber elastic body in directions perpendicular to the direction in which the second pressure receiving chamber and second equilibrium chamber are facing, thereby making it possible to establish a greater spring ratio in the radial direction in which the second pressure receiving chamber and second equilibrium chamber are facing, and the radial direction perpendicular thereto. It is thus possible to obtain damping effects based on the resonance action of the fluid flowing through the second orifice passage in the radial direction in which the second pressure receiving chamber and second equilibrium chamber are facing, while obtaining effective high dynamic spring properties based on the rubber elastic body in the radial direction perpendicular to the direction in which the second pressure receiving chamber and second equilibrium chamber are facing.

### BRIEF DESCRIPTION OF THE DRAWINGS

The forgoing and/or other objects features and advantages of the invention will become more apparent from the following description of a preferred embodiment with reference to the accompanying drawings in which like reference numerals designate like elements and wherein:

FIG. 1 is an elevational view in axial or vertical cross section of a fluid-filled vibration damping device in the form of an engine mount for use in an automotive vehicle, which is constructed according to the first embodiment of the invention, and taken along line 1-1 of FIG. 2;

FIG. 2 is a cross sectional view taken along line 2-2 of FIG. 1;

FIG. 3 is a front elevational view of a cylindrical orifice member of the engine mount of FIG. 1;

FIG. 4 is a top plane view of the orifice member of FIG. 3;

FIG. 5 is a right-side elevational view of the orifice member of FIG. 3;

FIG. 6 is a left-side elevational view of the orifice member of FIG. 3;

FIG. 7 is a graph demonstrating damping characteristics of the engine mount of this embodiment on the basis of resonance action of the fluid flowing through the second orifice passage; and

FIG. 8 is an elevational view in axial or vertical cross section of an engine mount for use in an automotive vehicle having a construction according to the second embodiment of the invention, corresponding to FIG. 1.

### DETAILED DESCRIPTION OF PREFERRED EMBODIMENTS

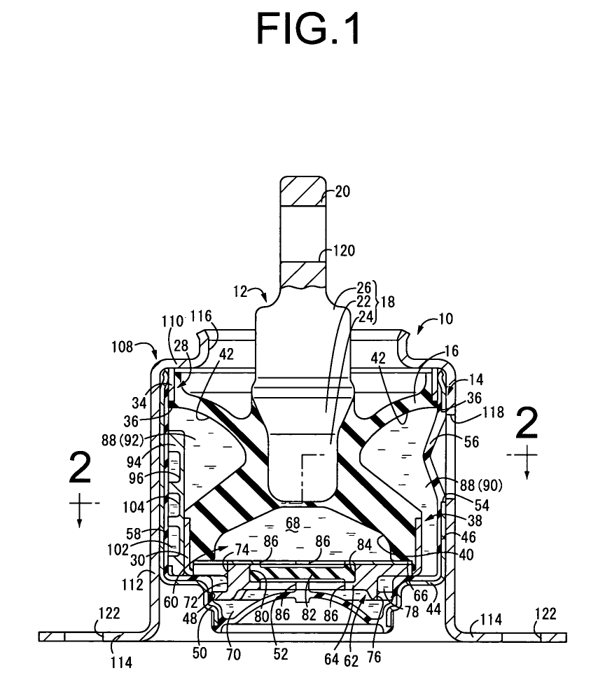

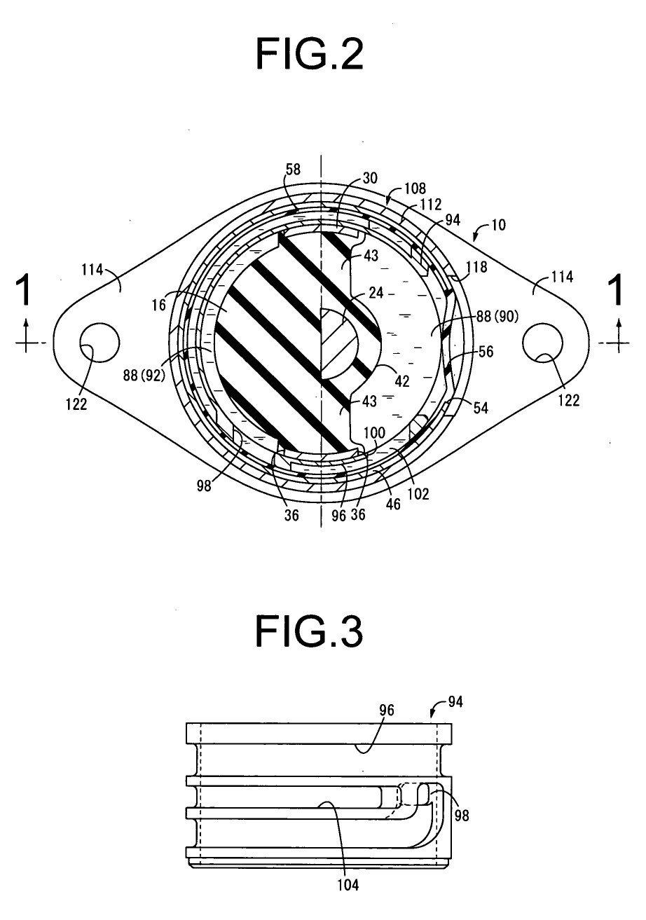

FIGS. 1 and 2 illustrate an automobile engine mount 10 in a first embodiment of the invention. This engine mount 10 has a construction wherein a metallic first mounting member 12 and a metallic second mounting member 14 are disposed apart, and a rubber elastic body 16 elastically connects the first mounting member 12 and second mounting member 14, with the first mounting member 12 attached to an automobile power unit and the second mounting member 14 attached to an automobile body by an attachment bracket 108, whereby the power unit is supported in a vibration-damped manner relative to the body. The engine mount 10 in this embodiment is mounted with the vertical direction in FIG. 1 being in a generally perpendicular vertical direction. As a rule, in the following description, the vertical direction refers to the vertical direction in FIG. 1.

More specifically, the first mounting member 12 comprises a support shaft 18 in the shape of a solid, round rod of small diameter, and a thick-walled, flatly expanding attachment fixing portion 20 is integrally formed on the center axis with the axial upper end of the straight, vertically extending support shaft 18. A tapered portion 22 is provided in the axial intermediate portion of the support shaft 18, with the axial bottom side of the support shaft 18 in the form of a small diameter portion 24 on one side of the tapered portion 22, and the axial upper side of the support shaft 18 in the form of a large diameter portion 26 on the other side of the tapered portion 22.

On the outer circumferential side of the first mounting member 12, a thin-walled, cylindrical metal sleeve 28 of large diameter is disposed generally coaxially on the center axis at a certain distance in the radial direction. Although not necessarily apparent in the drawings, the metal sleeve 28 has a stepped cylindrical configuration, in which a large diameter cylindrical portion 34 is integrally provided via a radially outward-expanding stepped component (not shown) with the one axial end (axial upper end) of a straight small diameter cylindrical portion 30 axially extending straight along generally the entire length. A pair of windows 36, 36 facing in the radial direction are formed in the axial intermediate portion of the metal sleeve 28. In this embodiment, each window 36 is open in the circumferential direction for a length less than half the circumference.

The first mounting member 12 and metal sleeve 28 having this structure are disposed so that the first mounting member 12 is inserted through the upper axial opening of the metal sleeve 28. When the first mounting member 12 is disposed in this way relative to the metal sleeve 28, the metal sleeve 28 is disposed at a distance in the radial direction around the entire small diameter portion 24 of the support shaft 18 in the first mounting member 12. With the first mounting member 12 thus disposed relative to the metal sleeve 28 in this way, the attachment fixing portion 20 of the first mounting member 12 is positioned protruding upward in the axial direction of the metal sleeve 28, while the axial bottom end of the support shaft 18 is positioned midway in the axial direction not as far as the axial bottom end of the metal sleeve 28.

The rubber elastic body 16 is disposed between the radially facing planes of the metal sleeve 28 and the support shaft 18 of the first mounting member 12 in the above positional relationship, and the first mounting member 12 and the metal sleeve 28 are elastically linked by the rubber elastic body 16. The rubber elastic body 16 has a thin-walled, cylindrical shape overall, the inner circumferential surface of which is bonded by vulcanization to the outer circumferential surface of the support shaft 18 of the first mounting member 12, while the outer circumferential surface is bonded by vulcanization to the inner circumferential surface of the metal sleeve 28. That is, in this embodiment, the rubber elastic body 16 is formed as an integrally vulcanized molded article 38 comprising the first mounting member 12 and metal sleeve 28.

A downwardly opening round recess 40 in the form of an inverted mortar of large diameter is formed in the center of the axial bottom end face of the rubber elastic body 16, and a pair of pockets 42, 42 open at the outer circumferential surface are formed on both sides in the radial direction of the support shaft 18 in the axial intermediate portion. The pair of pockets 42, 42 are formed to a length less than half the circumference in the circumferential direction, having an expanding open shape in which the width of the opening in the axial direction gradually increases as it approaches the open end, and are open at the outer circumferential surface through the pair of windows 36, 36 formed in the metal sleeve 28. As noted above, the pair of pockets 42, 42 are formed to a length less than half the circumference in the circumferential direction, so that a pair of connectors 43, 43 elastically link the first mounting member 12 and metal sleeve 28 in a direction perpendicular to the direction in which the pair of pockets 42, 42 are facing. That is, the pair of pockets 42, 42 are formed so as to be divided in the circumferential direction by the pair of connectors 43, 43. In this embodiment, the connectors 43, 43 are formed, with a width about ⅓ the size of the inside diameter of the small diameter cylindrical portion 30, so as to extend in directions perpendicular to the directions in which the pair of pockets 42, 42 are facing. Both the pair of pockets 42, 42 are also formed deviating a certain amount from the axial center of the rubber elastic body 16 in the axial direction, so that the axial bottom wall is thicker overall than the axial upper wall in the pockets 42.

The second mounting member 14, on the other hand, has a generally cylindrical bottomed shape of large diameter comprising a floor wall 44 and a peripheral wall 46. A large diameter through hole 48 is formed in the center of the floor wall 44, and a retaining cylinder 50 protruding axially downward is integrally formed at the peripheral edge of the opening of the through hole 48. A first diaphragm 52 is disposed as a first flexible rubber layer in the through hole 48 formed in the floor wall 44. The outer circumferential edge of the first diaphragm 52 is bonded by vulcanization to the retaining cylinder 50, so that the through hole 48 formed in the floor wall 44 of the second mounting member 14 is fluid-tightly closed by the first diaphragm 52. The first diaphragm 52 also has some slack, so that deformation can readily be accommodated.

The peripheral wall 46, on the other hand, extends generally straight in the axial direction, having a round shape of greater diameter than the metal sleeve 28, its axial length being generally the same as that of the metal sleeve 28. A window opening 54 is formed in the axial intermediate portion in the peripheral wall 46, and in this embodiment, the window opening 54 is smaller than the opening of the pockets 42. Incidentally, in this embodiment, the axial opening width of the window opening 54 is slightly smaller than the axial opening width of the pockets 42 formed in the rubber elastic body 16, and the circumferential opening width of the window opening 54 is about ⅓ that of the pockets 42 formed in the rubber elastic body 16. An outer peripheral edge of a second diaphragm 56 is thus bonded by vulcanization as the second flexible rubber layer to the peripheral edge of the opening of the window opening 54 formed in the peripheral wall 46, so that the window opening 54 is fluid-tightly closed by the second diaphragm 56. In this embodiment, the second diaphragm 56 is designed to slacken inward in the axis-perpendicular direction of the peripheral wall 46, and is as thick as the combined thickness of the peripheral wall 46 and a seal rubber layer 58 described below. The second diaphragm 56 is also formed with the same material as the first diaphragm 52.

In addition, the thin-walled seal rubber layer 58 integrally formed with the second diaphragm 56 is formed on the inner circumferential of the peripheral wall 46, covering generally the entire surface. In this embodiment, in particular, the seal rubber layer 58 is also integrally formed with the first diaphragm 52. That is, the first and second diaphragms 52 and 56 and the seal rubber layer 58 are integrally formed with the same rubber material.

The second mounting member 14 having this structure is fitted at one axial end to the integrally vulcanized molded article 38 of the rubber elastic body 16, and its diameter is reduced by being constricted on all sides while the one axial end (edge of open end) is positioned in the radially outward direction of the large diameter cylindrical portion 34 of the metal sleeve 28, so as to be fitted and fixed to the large diameter cylindrical portion 34.

When the second mounting member 14 is thus fitted and fixed to the metal sleeve 28, the first mounting member 12 is inserted into the opening of the second mounting member 14, so that the first mounting member 12 and second mounting member 14 are positioned on the same center axis.

While the second mounting member 14 is thus fitted and fixed to the metal sleeve 28, the axial bottom end face of the metal sleeve 28 abuts the floor wall 44 of the second mounting member 14, so that the metal sleeve 28 is positioned axially relative to the second mounting member 14. In addition, the seal rubber layer 58 is interposed in a compressed state between the surfaces where the metal sleeve 28 and second mounting member 14 are in contact with each other.

In addition, when the second mounting member 14 is thus fitted and fixed to the metal sleeve 28, the opening of the second mounting member 14 on the peripheral wall 46 side is fluid-tightly closed by the rubber elastic body 16, so that a liquid chamber 60 in which a non-compressible fluid is sealed is formed between the facing surfaces of the rubber elastic body 16 and first diaphragm 52. Examples of sealed fluids which can be used include water, alkylene glycols, polyalkylene glycols, silicone oils, and mixtures thereof. The use of a low viscosity fluid with a viscosity no greater than 0.1 Pa.s is particularly desirable in order to effectively obtain damping effects based on the resonance action of the fluid flowing through the orifice passages.

A partition member 62 which is generally disk-shaped as a whole is disposed expanding in the axis-perpendicular direction of the second mounting member 14. The partition member 62 is formed by superposing a thin-walled disk-shaped lid clamp 66 on the upper surface of a thin-walled disk-shaped partition clamp 64, and the outer peripheral edges of the lid clamp 66 and partition clamp 64 are intimately superposed on each other and held under pressure between the floor wall 44 of the second mounting member 14 and the axial bottom end face of the outer peripheral edge of the rubber elastic body 16, so as to be housed between the facing surfaces of the first diaphragm 52 and rubber elastic body 16.

When the partition member 62 is housed in this manner between the facing surfaces of the first diaphragm 52 and the rubber elastic body 16, the liquid chamber 60 formed between the facing surfaces of the first diaphragm 52 and rubber elastic body 16 is vertically divided by the partition member 62. Part of the wall is thus formed by the rubber elastic body 16 on the upper side of the partition member 62, forming a first pressure receiving chamber 68 in which pressure fluctuations are produced on the basis of the elastic deformation of the rubber elastic body 16 when vibrations are input, whereas on the bottom side of the partition member 62, part of the wall is formed by the first diaphragm 52, forming a first equilibrium chamber 70 in which changes in volume can be readily accommodated on the basis of the deformation of the first diaphragm 52.

The partition clamp 64 includes a recess 72 open in its outer circumferential surface and extending in its circumferential direction with a length less than half the circumference thereof. An opening of the recess 72 is fluid-tightly closed by the second mounting member 14. This results in the formation of a first orifice passage 78, the outer periphery of the partition member 62 being extended in the circumferential direction, with one end in the circumferential direction connected to the first pressure receiving chamber 68 through a communication hole 74, and the other end in the circumferential direction connected to the first equilibrium chamber 70 through a communication hole 76. The fluid flows between the first pressure receiving chamber 68 and first equilibrium chamber 70 through the first orifice passage 78. In this embodiment, the length, cross section area, and the like of the first orifice passage 78 are adjusted so as to bring about high attenuation effects on against vibrations in the low frequency range, corresponding to engine shake, based on the resonance action of the fluid flowing through the first orifice passage 78.

A round center recess 80 open at the top is formed in the center portion of the partition clamp 64, and the opening of the center recess 80 is covered by the lid clamp 66. A movable rubber plate 82 in the form of a disk of a certain thickness is housed in the center recess 80. An annular support 84 with thicker walls then the center portion is formed in the outer peripheral edge in the movable rubber plate 82, and the annular support 84 is pinched between the partition clamp 64 and lid clamp 66. As a result, the movable rubber plate 82 is disposed in a state where a certain level of axial elastic deformations can be accommodated in the center recess 80.

A plurality of through holes 86 are provided in both vertical walls of the center recess 80 formed by the partition clamp 64 and lid clamp 66, and the hydraulic pressure in the first pressure receiving chamber 68 and first equilibrium chamber 70 is exerted on the upper and lower surfaces of the movable rubber plate 82 disposed in the center recess 80. The movable rubber plate 82 is elastically deformed based on the difference between the hydraulic pressure in the first equilibrium chamber 70 exerted on the lower surface of the movable rubber plate 82 and the hydraulic pressure in the first pressure receiving chamber 68 exerted on the upper surface of the movable rubber plate 82, substantially resulting in the flow of fluid between the first equilibrium chamber 70 and the first pressure receiving chamber 68 through the center recess 80 and through holes 86 formed in the lid clamp 66 and partition clamp 64, respectively, according to the level of elastic deformation in the movable rubber plate 82, thereby attenuating or absorbing the fluctuations in the pressure of the first pressure receiving chamber 68.

The level of the elastic deformation of the movable rubber plate 82 is limited by the elasticity of the movable rubber plate 82 and the contact of the movable rubber plate 82 on the inner surface of the center recess 80. Therefore, during the input of vibrations in a narrow range of high frequencies, such as booming noises, the fluctuations in the pressure of the first pressure receiving chamber 68 can be beneficially absorbed or attenuated on the basis of the elastic deformation of the movable rubber plate 82, whereas the level of elastic deformation in the movable rubber plate 82 is limited during the input of vibrations with a broader range of low frequencies, such as engine shake, thus prompting beneficial pressure fluctuations in the first pressure receiving chamber 68.

Furthermore, the second mounting member 14 is fitted and fixed to the metal sleeve 28, so that the windows 36, 36 of the metal sleeve 28 are fluid-tightly closed by the second mounting member 14. As a result, the openings of the pair of pockets 42, 42 are closed by the second mounting member 14, forming a pair of operating fluid chambers 88, 88 in which a non-compressible fluid is sealed. The same non-compressible fluid sealed in the liquid chamber 60 is sealed in both of the pair of operating fluid chambers 88, 88.

In this embodiment, when the second mounting member 14 is fitted and fixed to the metal sleeve 28, the window opening 54 formed in the peripheral wall 46 of the second mounting member 14 is positioned in the radial outward direction of either of the pair of windows 36, 36 formed in the metal sleeve 28, so that the second diaphragm 56 is positioned in the radial outward direction of either of the pair of pockets 42, 42.

As a result, in this embodiment, by means of either of the pair of operating fluid chambers 88, 88, a second equilibrium chamber 90 is formed, in which part of the wall is formed by the second diaphragm 56, allowing changes in volume to be readily accommodated on the basis of the deformation of the second diaphragm 56, whereas by means of the other operating fluid chamber 88, a second pressure receiving chamber 92 is formed, in which part of the wall is formed by the rubber elastic body 16, so that fluctuations in pressure are produced directly in conjunction with the elastic deformation of the rubber elastic body 16 during vibration input.

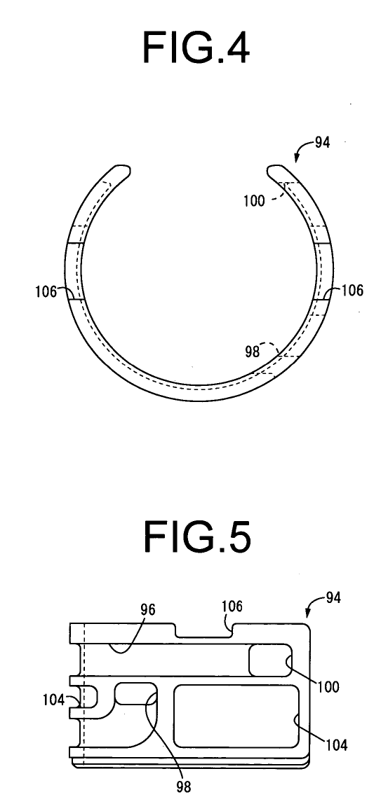

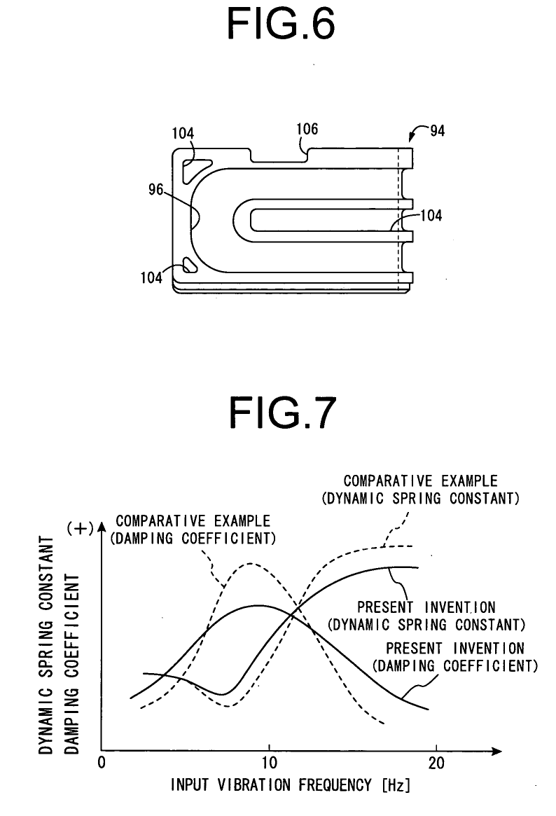

A tubular orifice member 94 is disposed between the axial-perpendicular facing surfaces of the second mounting member 14 and metal sleeve 28. As illustrated in FIGS. 3 through 6, the tubular orifice member 94 is generally cylindrical, with a circumferential length that is at least half the circumference (a length about ¾ of the circumference in this embodiment), ad is formed by means of a hard material such as synthetic resin or metal. The inside diameter of the tubular orifice member 94 is slightly greater than the outside diameter of the small diameter cylindrical portion 30 in the metal sleeve 28, whereas the outside diameter of the tubular orifice member 94 is about the same as the outside diameter of the large diameter cylindrical portion 34 in the metal sleeve 28. Furthermore, the tubular orifice member 94 is assembled with the metal sleeve 28 by being inserted axially upward through the small diameter cylindrical portion 30 in the metal sleeve 28. With the tubular orifice member 94 thus assembled with the metal sleeve 28 in this way, the upper end of the tubular orifice member 94 extends to the window 36, being positioned in the axial intermediate portion of the window 36. On the other hand, the bottom end of the tubular orifice member 94 is positioned in contact with the floor wall 44 of the second mounting member 14, and is pinched along the entire circumference between the peripheral wall 46 of the second mounting member 14 and the opening side edge of the small diameter cylindrical portion 30 of the metal sleeve 28. In this embodiment, the tubular orifice member 94 is positioned where the second diaphragm 56 will not to circumferentially cross over the pocket 42 positioned radially outward, so as not to interfere with the deformation of the second diaphragm 56, so as not to interfere with the deformation of the second diaphragm 56. In particular in this embodiment, the second diaphragm 56 is positioned at the circumferentially divided part of the tubular orifice member 94. That is, the second diaphragm 56 is positioned so as to be flanked by the one and the other circumferential ends of the tubular orifice member 94.

A recess 96 that is circumferentially reciprocal, corrugated, or the like is formed open at the outer circumferential surface in the tubular orifice member 94. One end of the recess 96 is connected to one operating fluid chamber 88 (second pressure receiving chamber 92) through a through hole 98 in the floor wall of the recess 96, and the other circumferential end of the recess 96 is connected to the other operating fluid chamber 88 (second equilibrium chamber 90) through a through hole 100 in the floor wall of the recess 96. The recess 96 is fluid-tightly covered by the peripheral wall 46 of the second mounting member 14, resulting in the formation of a second orifice passage 102 through which the pair of operating fluid chambers 88, 88, that is, the second pressure receiving chamber 92 and second equilibrium chamber 90, communicate with each other. In this embodiment, the length, cross section area, or the like of the second orifice passage 102 is adjusted so as to bring about highly attenuating effects on low frequency vibrations such as engine shake, on the basis of the resonance action of the fluid circulating between the second pressure receiving chamber 92 and second equilibrium chamber 90 through the second orifice passage 102. A notched recess 104 of suitable shape and size is formed in the tubular orifice member 94 of this embodiment.

Although not shown, the outer circumferential surface of the metal sleeve 28 is provided with an engagement protrusion formed by means of a rubber elastic body, axially protruding from the large diameter cylindrical portion 34 is fixed between the pair of windows 36, 36 in the small diameter cylindrical portion 30. A rectangular positioning notch 106 formed with an opening at the axial upper surface in the tubular orifice member 94 engages with the engagement protrusion, so that the tubular orifice member 94 is circumferentially positioned at the integrally vulcanized molded article 38 (metal sleeve 28).

In this embodiment, when the tubular orifice member 94 is fitted to the metal sleeve 28, the diameter of the metal sleeve 28 is first reduced by being constricted on all sides, for example, so that preliminary compression is exerted on the rubber elastic body 16. As a result, tensile stress produced in the rubber elastic body 16 when the rubber elastic body 16 is vulcanized and molded can be attenuated or neutralized to improve the durability and withstand load of the rubber elastic body 16.

The attachment bracket 108 is attached to the engine mount 10 having this structure. The attachment bracket 108 is in the form of an inverted cup, as a whole comprising an upper floor 110 and a cylindrical portion 112. A radially outward protruding attachment flange 114 is integrally formed with the open end. The attachment bracket 108 having this structure is assembled with the engine mount 10 by being fitted and fixed to the peripheral wall 46 of the second mounting member 14. With the attachment bracket 108 thus assembled with the engine mount 10, the first mounting member 12 protrudes above the upper floor 110 from an insertion hole 116 formed in the upper floor 110.

In this embodiment, a through hole 118 is formed in the cylindrical portion 112 of the attachment bracket 108 for positioning on the outside of the window opening 54 fluid-tightly closed by the second diaphragm 56 while the attachment bracket 108 is assembled on the engine mount 10, so that atmospheric pressure is exerted on the second diaphragm 56.

The engine mount 10 on which the attachment bracket 108 has thus been assembled is such that the fixing portion 20 of the first mounting member 12 is fixed to the power unit (not shown) by a bolt (not shown) that is inserted into an attachment hole 120 in the fixing portion 20, while the second mounting member 14 is fixed to the automobile body by a bolt (not shown) that is inserted into a bolt through hole 122 formed in the attachment flange 114, so that the power unit is supported in a vibration-damping manner on the body. In this embodiment, the engine mount 10 is mounted on a vehicle, with the radial direction in which the second pressure receiving chamber 92 and second equilibrium chamber 90 are facing oriented in the generally longitudinal direction of the vehicle.

Relative differences in pressure are produced between the first pressure receiving chamber 68 and first equilibrium chamber 70 when generally vertical vibrations are input between the first mounting member 12 and second mounting member 14 while the engine mount 10 is mounted on the vehicle in the manner described above. When vibrations in a broad range of low frequencies such as engine shake are input in the generally vertical direction between the first mounting member 12 and second mounting member 14, highly attenuating effects are brought about on the basis of the resonance action of the fluid flowing through the first orifice passage 78. When vibrations in a narrow range of high frequencies such as booming noises are input in the generally vertical direction between the first mounting member 12 and second mounting member 14, the fluctuations in the pressure of the first pressure receiving chamber 68 is absorbed or attenuated on the basis of the elastic deformation of the movable rubber plate 82, resulting in vibration insulating effects due to the low dynamic spring action.

On the other hand, relative differences in pressure are produced between the second pressure receiving chamber 92 and second equilibrium chamber 90 when generally horizontal vibrations are input between the first mounting member 12 and second mounting member 14 while the engine mount 10 is mounted on the vehicle in the manner described above. When vibrations in a broad range of low frequencies such as engine shake are input in the generally horizontal direction between the first mounting member 12 and second mounting member 14, highly attenuating effects are brought about on the basis of the resonance action of the fluid flowing through the second orifice passage 102.

In the engine mount 10 of this embodiment, a pair of operating fluid chambers 88, 88 are formed in facing positions on both sides in the radial direction of the support shaft 18 in the first mounting member 12, and either of the pair of operating fluid chambers 88, 88 is partially formed by the second diaphragm 56 so as to provide the second equilibrium chamber 90. By means of the other operating fluid chamber 88, the second pressure receiving chamber 92 is formed, in which part of the wall is formed by the rubber elastic body 16, so that fluctuations in pressure are produced directly in conjunction with the elastic deformation of the rubber elastic body 16 when vibrations are input in generally the horizontal direction (generally longitudinal direction of the vehicle) between the first mounting member 12 and second mounting member 14. It is thus possible to adjust the wall spring rigidity of the second equilibrium chamber 90 by adjusting the spring properties of the second diaphragm 56.

Accordingly, in the engine mount 10 of this embodiment, the wall spring rigidity of the second equilibrium chamber 90 can be adjusted with a greater degree of freedom without altering the spring properties of the rubber elastic body 16 which affects the axial support spring rigidity and the like, and the range of frequencies in which damping effects can be brought about on the basis of the resonance properties of the fluid flowing through the second orifice passage 102 can thus be tuned with a greater degree of freedom.

In the engine mount 10 of this embodiment, the second orifice passage 102 links the second pressure receiving chamber 92 and second equilibrium chamber 90 together, thus making it possible to control the peaky properties of the damping effects brought about on the basis of the resonance action of the fluid flowing through the second orifice passage 102, and thereby making it possible to expand the range of frequencies amenable to damping effects brought about on the basis of the resonance action of the fluid flowing through the second orifice passage 102.

In addition, in the engine mount 10 of this embodiment, no dead space or the like is formed in connectors 43, 43 formed so as to radially extend perpendicular to the radial direction in which the pair of pockets 42, 42 are facing, that is, the radial direction in which the second pressure receiving chamber 92 and second equilibrium chamber 90 are facing. This makes it possible to allow the rubber volume of the connectors 43, 43 to be increased, so that a greater spring ratio can be established in the radial direction perpendicular to the direction in which the second pressure receiving chamber 92 and second equilibrium chamber 90 are facing and the radial direction in which the second pressure receiving chamber 92 and second equilibrium chamber 90 are facing.

Thus, in the engine mount 10 of this embodiment, when vibrations are input in the radial direction in which the second pressure receiving chamber 92 and second equilibrium chamber 90 are facing, it is possible to bring about damping effects based on the resonance action of the fluid flowing through second orifice passage 102. On the other hand, when vibrations are input in the radial direction perpendicular to the direction in which the second equilibrium chamber 90 and second pressure receiving chamber 92 are facing, the pair of connectors 43, 43 undergo compression and expansion, making it possible to obtain effective high dynamic spring properties by the rubber elastic body 16.

Incidentally, FIG. 7 shows the results obtained in an example, where the engine mount 10 having a structure according to the embodiment was used in a simulation of the frequency properties for damping performance against vibrations input in the axis-perpendicular direction in which the second pressure receiving chamber 92 and second equilibrium chamber 90 were facing. FIG. 7 also shows the results of a comparative example after the same simulation was performed with an engine mount having a structure in which the openings of the pair of pockets 42, 42 were both covered by a rigid peripheral wall 46, without forming a window opening 54 in the second mounting member 14 of the engine mount 10.

The results in FIG. 7 reveal that the damping effects brought about on the basis of the resonance action of the fluid flowing through the second orifice passage 102 in the engine mount 10 of this embodiment were obtained over a broad range of frequencies.

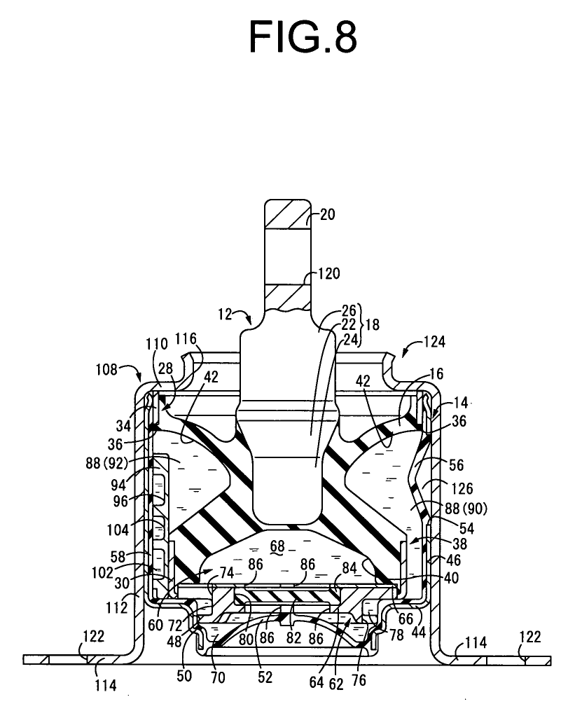

FIG. 8 illustrates an automobile engine mount 124 in a second embodiment of the invention. Members and locations which are the same as in the first embodiment will be designated in the drawings with the same symbols used in the first embodiment, and will therefore not be further elaborated.

Specifically, in the first embodiment, a through hole 118 was formed in the cylindrical portion 112 of the attachment bracket 108, but in this embodiment, no through hole 118 is formed in the cylindrical portion 112, so that the outside of the second diaphragm 56 is covered by the cylindrical portion 112, resulting in the formation of a sealed air chamber 126 on the side opposite the second equilibrium chamber 90, on both sides of the second diaphragm 56.

The same effects as in the engine mount 10 of the first embodiment can be obtained in the engine mount 124 of this embodiment having this structure.

In the engine mount 124 of this embodiment, since the sealed air chamber 126 is formed on the side opposite the second equilibrium chamber 90, on both sides of the second diaphragm 56, the compressive elasticity of the air sealed in the air chamber 126 can be utilized to adjust the spring properties of the second diaphragm 56. Thus, the range of frequencies in which damping effects can be brought about on the basis of the resonance action of the fluid flowing through the second orifice passage 102 can be tuned with an even greater degree of freedom.

Although several embodiments of the invention have been described above, they are ultimately only examples, and the invention should not be understood as being limited in any way by the specific descriptions of the embodiments.

For example, in the first and second embodiments, part of the walls in the first pressure receiving chamber 68 and first equilibrium chamber 70 were formed by the movable rubber plate 82, which absorb pressure fluctuations in the high frequency range, but the movable rubber plate 82 may be designed according to the desired vibration properties, and is by no means necessary in the invention.

Furthermore, the tuning frequencies, length and cross section area of the first and second orifice passages 78 and 102 may be determined as desired according to the desired vibration properties, and are not limited to those in the first and second embodiments.

In addition, in the first and second embodiments, only one window opening 54 was formed, but a plurality of window openings 54 may also be formed. The size of the window openings 54 is also not limited to that in the first and second embodiments.

It is also to be understood that the present invention may be embodied with various other changes, modifications and improvements, which may occur to those skilled in the art, without departing from the spirit and scope of the invention defined in the following claims.

What is claimed is:

1. A fluid-filled vibration damping device comprising:
a first mounting member having a linearly extending support shaft;
a second mounting member having a generally cylindrical shape and coaxially disposed with and axially spaced away from the first mounting member such that the support shaft of the first mounting member is inserted so as to extend axially inwardly from a first axial opening of the second mounting member;
a rubber elastic body elastically connecting the support shaft of the first mounting member and the second mounting member so that the first axial opening of the second mounting member is fluid-tightly closed by means of the rubber elastic body;
a first flexible rubber layer fluid-tightly closing an other axial opening of the second mounting member;
a partition member supported by the second mounting member and disposed between the rubber elastic body and the first flexible rubber layer so as to extend in an axis-perpendicular direction of the second mounting member;
a first pressure receiving chamber partially formed by the rubber elastic body on one axial side of the partition member, having a non-compressible fluid sealed therein;
a first equilibrium chamber partially formed by the first flexible rubber layer on an other axial side of the partition member, having the non-compressible fluid sealed therein;
a first orifice passage permitting a fluid communication between the first pressure receiving chamber and the first equilibrium chamber;
a pair of pockets having openings open in an outer circumferential surface of the rubber elastic body and being located on both sides in a diametric direction of the support shaft of the first mounting member, the openings of the pair of pockets being fluid-tightly covered by the second mounting member so as to form a pair of operating fluid chambers partially formed by the rubber elastic body and having the non-compressible fluid sealed therein; and
a second orifice passage permitting a fluid communication between the pair of operating fluid chambers,
wherein the second mounting member includes a window opening provided in a portion covering one of the pair of operating fluid chambers, and the window opening is fluid-tightly closed by a second flexible rubber layer so that the one operating fluid chamber is partially formed by the second flexible rubber layer, thereby forming, by means of the pair of operating fluid chambers, a second pressure receiving chamber partially formed by the rubber elastic body so that pressure fluctuations are directly produced in conjunction with an elastic deformation of the rubber elastic body when vibrations are input in the axis-perpendicular direction between the first and second mounting members, and a second equilibrium chamber partially formed by the second flexible rubber layer so that changes in volume are readily accommodated through a deformation of the second flexible rubber layer.

2. A fluid-filled vibration damping device according to claim 1, wherein both the first flexible rubber layer and second flexible rubber layer are bonded by vulcanization to the second mounting member so that the other axial opening of the second mounting member is fluid-tightly closed by the first flexible rubber layer, and the window opening of the second mounting member is fluid-tightly closed by the second flexible rubber layer.

3. A fluid-filled vibration damping device according to claim 2, wherein the first and second flexible rubber layers are integrally formed of a same rubber material, and a seal rubber layer covering an inner circumferential surface of the second mounting member over generally an entire surface is integrally formed with the first and second flexible rubber layers and bonded by vulcanization to the second mounting member.

4. A fluid-filled vibration damping device according to claim 1, wherein a generally cylindrical metal sleeve is bonded by vulcanization to the outer circumferential surface of the rubber elastic body, a pair of windows is formed in the metal sleeve, and wherein the pair of pockets formed in the rubber elastic body opens through the pair of windows to an outer circumferential surface of the metal sleeve, and the second mounting member is fitted and secured to the metal sleeve so that the pair of windows in the metal sleeve are fluid-tightly covered by the second mounting member.

5. A fluid-filled vibration damping device according to claim 1, further comprising: an attachment bracket having cylindrical portion that are fitted and secured to the second mounting member so that the second flexible rubber layer disposed at the window opening of the second mounting member is covered from an outside by the cylindrical portion of the attachment bracket so as to form a sealed air chamber on a side opposite the second equilibrium chamber with the second flexible rubber layer interposed therebetween.

6. A fluid-filled vibration damping device according to claim 1, wherein the pair of pockets are formed deviating a certain amount from an axial center of the rubber elastic body in an axial direction so that each of the pockets has an axial bottom wall thicker overall than an axial upper wall thereof.
